(19) United States
(12) Patent Application Publication
(10) Pub. No.: US 2007/0140530 A1
(43) Pub. Date: Jun. 21, 2007

(54) Method and apparatus for providing fingerprint authentication and actuation

(76) Inventors: John M. Coogan, Lansdale, PA (US); Jeffrey D. Ollis, Dresher, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/312,263

(22) Filed: Dec. 20, 2005

(51) Int. Cl. G06K 9/00

(52) U.S. Cl. 382/115; 340/5.53; 382/124; 726/26

(57) ABSTRACT

A method and apparatus of providing combined secure access and command execution for an electronic device is disclosed. Fingerprint representation data from a user is received. The user is authenticated when the fingerprint representation data received from the user matches user fingerprint data. A determination is made as to whether a user command is associated with the user fingerprint data when the fingerprint representation data received from the user matches the user fingerprint data. The user command is executed when the user command is associated with the user fingerprint data.

### BACKGROUND OF THE DISCLOSURE

1. Field of the Disclosure

The present disclosure relates to authentication systems. In particular, it relates to authentication systems based on fingerprinting.

2. General Background

Modern security systems utilize various authentication techniques. One such technique is fingerprint authentication. Fingerprints offer secure and unique validation data that does not require user memorization of a code, and is readily available to the user. Furthermore, fingerprint authentication permits a fast, clean and efficient means to read a user identity and verify whether the user is granted access to a specific system.

Other forms of authentication include entering pins and passwords in a keypad, keyboard, etc., which require user memorization of a particular sequence of characters and symbols. Once a user is granted access, current systems provide a user a selection of commands to operate the system. User commands are generally executed without verification of identity or authentication of source. As such, once an electronic device or system grants access to a user, commands are executed with the risk that another user may enter the command. In addition to having to remember passwords, and other validating codes, users have to conceal the information and at the same time keep such information available to themselves for future reference.

### SUMMARY

In one aspect, there is a method of providing combined secure access and command execution for an electronic device. Fingerprint representation data from a user is received. The user is authenticated when the fingerprint representation data received from the user matches user fingerprint data. A determination is made as to whether a user command is associated with the user fingerprint data when the fingerprint representation data received from the user matches the user fingerprint data. The user command is executed when the user command is associated with the user fingerprint data.

In another aspect, there is a system that provides combined secure access and command execution for an electronic device. The system comprises a fingerprint database, a fingerprint recognition module, a user maintenance module, and a computer processor. The fingerprint database stores user fingerprint data. The fingerprint recognition module authenticates the user by determining when fingerprint representation data received from a user matches user fingerprint data stored in the fingerprint database. The user maintenance module determines whether a user command is associated with the fingerprint representation data. The computer processor executes the user command when the user command is associated with the user fingerprint data.

### BRIEF DESCRIPTION OF THE DRAWINGS

By way of example, reference will now be made to the accompanying drawings.

FIG. 1 shows a fingerprint authentication and actuating unit.

FIGS. 2A-2C illustrate examples of electronic devices that may be coupled with the fingerprint authentication and actuation unit.

FIG. 3 illustrates ten fingerprints corresponding to each of the fingerprints of a user.

FIG. 4 illustrates a table of commands that may be associated with each of the fingerprints of a user.

FIG. 5 illustrates a process flow diagram of the authentication and actuation of a fingerprint.

FIG. 6 illustrates a table of commands and command strings that may be associated with each of the fingerprints of a user.

FIG. 7 illustrates a process flow diagram of the authentication and actuation of a fingerprint.

FIG. 8 illustrates fingerprint combinations that correspond to each of the fingerprints of a person.

FIG. 9 illustrates a table of function commands that may be associated with each of the fingerprints and sequence of fingerprints of a user.

### DETAILED DESCRIPTION

A method and apparatus of fingerprint authentication and operation is disclosed. The system and method permit a user to utilize fingerprints as the primary method of authentication. Fingerprints are generally accepted to be a unique identifier of an individual. In addition to user identification, fingerprints may be utilized as system commands. Fingerprints quickly and accurately read by an electronic device. Thus, when combined with an associated command, fingerprints provide an authenticated command.

As such, user fingerprints may be unique identifiers of the user and of a pre-configured command. In addition, fingerprint sequences are also unique identifiers of pre-configured commands. Fingerprints work as unique keys to activate and trigger pre-configured operations to be executed. For example, integrated into a home automation system, the user's left hand index finger, when read and verified causes the door to unlock and the lights to come on. In another example, the right hand index finger unlocks the door and causes the system to send a signal to the police that a home intrusion is underway.

With fingerprint identification and authentication, the user no longer needs to remember passwords and access codes. The fingerprints may be used to identify and authenticate the user, grant access to the system and provide system function commands. The system commands are configured to be executed immediately after the user provides a fingerprint. Furthermore, each fingerprint belonging to each finger is programmed so as to offer a specific command. Finally, each fingerprint may also be associated with a string of commands, and not only a single command.

Fingerprint Authentication and Actuation Unit

The recognition of fingerprints is done in relation to various electrical devices that require user authentication and interaction. In one embodiment, an electrical device is configured to perform the functions of a fingerprint authentication and actuation unit. In another embodiment, the electrical device is connected to a fingerprint and authentication unit.

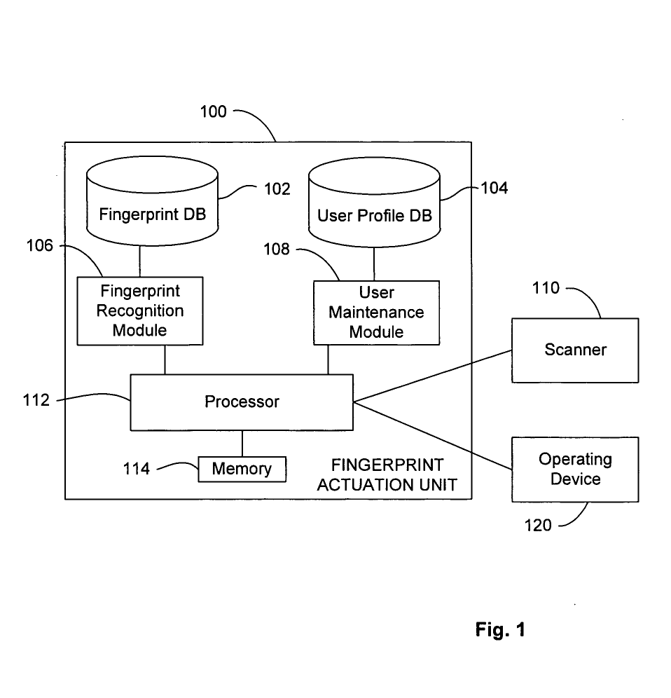

FIG. 1 shows a fingerprint authentication and actuating unit. The fingerprint authentication and actuating unit 100 may include a fingerprint database 102, a user profile database 104, a fingerprint recognition module 106, a user maintenance module 108, a processor 112, and a random access memory 114. In addition, the fingerprint authentication and actuating unit 100 includes a fingerprint scanner 110 for scanning a fingerprint for scanning a fingerprint 123 of a finger 121 to generate an image of the fingerprint 123. In one embodiment, the scanner 110 is communicated with the fingerprint authentication unit. In another embodiment, the fingerprint scanner 110 is integrated to the fingerprint authentication and actuating unit 100.

The fingerprints database 102 stores fingerprint data for each user in the user profile database 104. In one embodiment, each user has multiple fingerprints. In another embodiment, each user has a fingerprint image stored in the fingerprint database 102. The fingerprint recognition module 106 includes logic to store the fingerprints associated with each user. In one embodiment, the logic includes comparison of the fingerprint of a user with the fingerprints scanned by the scanner 110. If a threshold of similarity is surpassed by a predefined number of fingerprint features, then the scanned fingerprint is authenticated as belonging to the user associated with the fingerprint features deemed similar to the scanned fingerprint. In another embodiment, if a threshold of similarity is surpassed by at least one fingerprint feature, then the scanned fingerprint is authenticated as belonging to the user associated with the fingerprint feature deemed similar to the fingerprint features in the user's fingerprint.

In one example, the fingerprint recognition module 106 stores images for five fingerprint features of a particular fingerprint associated with the user. In another example, the fingerprint recognition module 106 stores measurements of each of the fingerprints of a user. In yet another example, the fingerprint recognition module 106 stores blueprints of each of the fingerprints of a user. In another example, the fingerprint recognition module 106 stores a single image of the user's fingerprint.

The user profile database 104 stores user preferences, alternative identification codes, pre-defined commands, and other user-specific data. The user maintenance module 108 includes logic to perform user profiling. In one embodiment, the maintenance module includes logic to extract a user profile based on a user identifier. The user identifier may be, for example, the fingerprints stored in the fingerprint database 102. In another embodiment, the maintenance module 108 includes logic to save user settings under the user's profile. In another embodiment, the maintenance module 108 includes logic to interpret user operations as a user preference and save the user preference under the user's profile. In another embodiment, the maintenance module 108 includes logic to interpret user operations as a user preference and save the user preference under the user's profile. In yet another embodiment, the maintenance module 108 includes logic to add a new user if the user is not associated with an existing user profile. In another embodiment, the maintenance module 108 includes logic to execute a command pre-stored and associated with an existing user profile.

In one embodiment, the fingerprint authentication and actuation unit 100 may exist in two separate housings, such that fingerprint authentication is provided by a first module and fingerprint actuation is provided by a second module. As described in detail below, fingerprint authentication entails receiving a fingerprint, for example through the scanner 110, and verifying that the user providing the fingerprint is an authorized user by searching the provided fingerprint in the fingerprint database 102. Fingerprint actuation may include determining whether the provided fingerprint has been correlated with a particular function, and executing the command corresponding to the correlated function.

In one embodiment, the fingerprint database 102 is a read-only memory (ROM) lookup table for storing data representative of an authorized user's fingerprint. The fingerprint recognition module 106 may include logic for comparing the fingerprint scanned by scanner 110 with the data representing an authorized user's fingerprint stored in fingerprint database 102.

In another embodiment, the user profile database 104 is a read-only memory in which user preferences, pre-configured function commands, associated permissions, etc. are stored. The user maintenance module retrieves and stores data on the user profile database 104 to update the pre-configured commands, preferences, etc. Finally, a computer processor 112 may be communicated with the fingerprint recognition module 106 and the user maintenance module 108 to execute operations such as comparing incoming fingerprints through the finger recognition module 106, and requesting user preferences, profile and other data associated with an existing user.

In another embodiment, the fingerprint database 102, a user profile database 104, the fingerprint recognition module 106, the user maintenance module 108, the computer processor 112, and the random access memory 114 are an integral part of the operating device. For example, a processor in the operating device 120 may be the same processor as the computer processor 112.

The computer processor 112 may further be communicated with an operating device 120, such as for example a personal data assistant, a handheld device, a home appliance, an automated teller machine, a vehicle, etc.

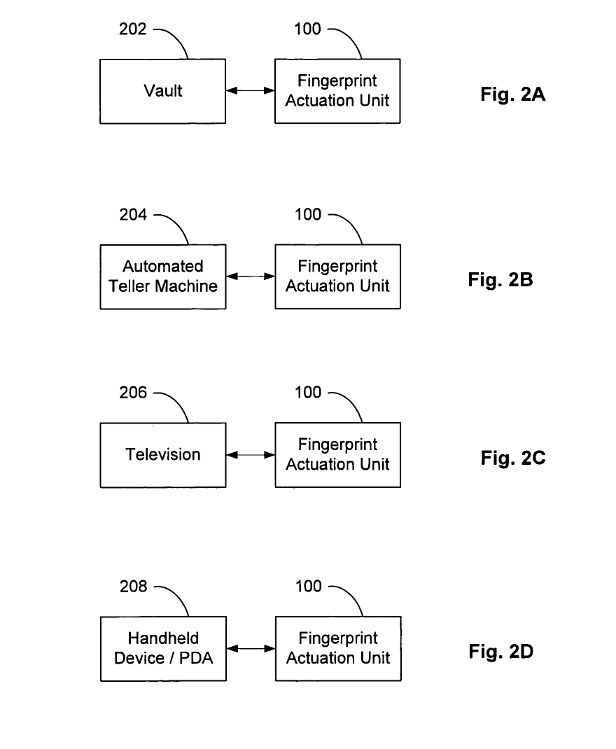

FIGS. 2A, 2B, 2C and 2C illustrate examples of electronic devices that may be coupled with the fingerprint authentication and actuation unit 100. As described in detail below, each of these electronic devices are operated depending on different configurations of fingerprint input. For example, a secure vault system 202 used in a bank may benefit from fingerprint authentication, where for example depending on the hierarchical level of the person providing the fingerprint, more or less access can be provided. In another example, an automated teller machine 204 can provide further functionality to each of the customers based on the fingerprint input provided by the customer. In yet another example, a television unit 206, can include operations such as disable parental control, or enable parental control with the touch of an authorized fingerprint. In another example, a handheld device 208 can be unlocked or locked using the owners fingerprint. Other operations can also be executed. For example, speed dial can be implemented with the touch of each of the fingerprints of the user. Thus, a fingerprint of the index finger can trigger a speed dial to the spouse of the user, while a fingerprint of the middle finger can trigger a speed dial to the workplace of the user.

In one embodiment, these systems are coupled and communicated with the fingerprint authentication and actuation unit 100. In another embodiment, these systems include the fingerprint authentication and actuation unit 100 as an integral part of their configuration.

Fingerprint Actuation

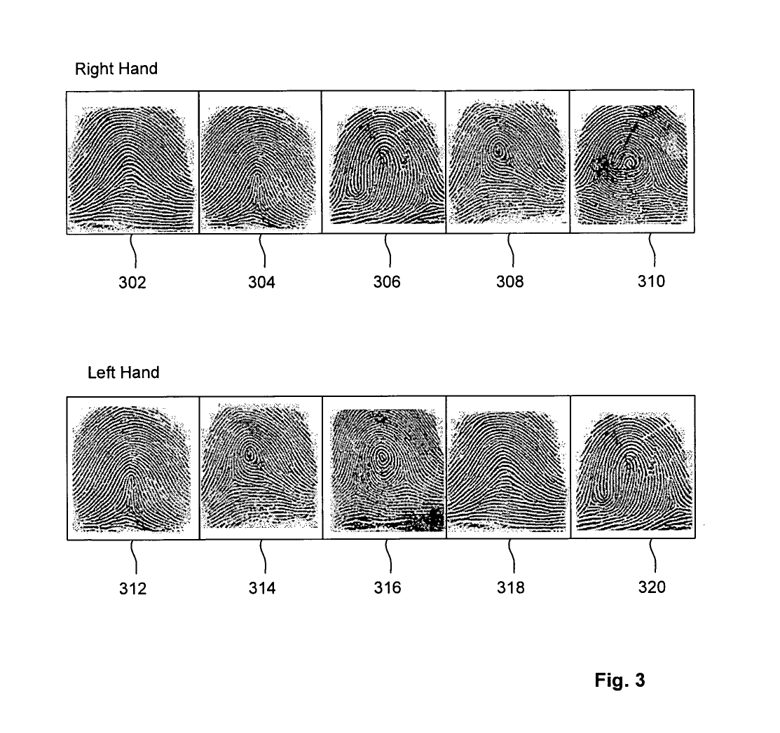

FIG. 3 illustrates ten fingerprints corresponding to each of the fingerprints of a user. Fingerprints 302, 304, 306, 308 and 310 all represent fingerprints for the right hand. Fingerprint 302 represents the fingerprint of thumb. Fingerprint 304 represents the fingerprint of an index finger. Fingerprint 306 represents the fingerprint of middle finger. Fingerprint 308 represents the fingerprint of a ring finger. Fingerprint 310 represents the fingerprint of a little finger.

Fingerprints 312, 314, 316, 318 and 320 all represent fingerprints for the left hand. Fingerprint 312 represents the fingerprint of a thumb. Fingerprint 314 represents the fingerprint of an index finger. Fingerprint 316 represents the fingerprint of a middle finger. Fingerprint 318 represents the fingerprint of a ring finger. Fingerprint 320 represents the fingerprint of a little finger.

Each finger is unique and has a unique fingerprint. The system takes advantage of the uniqueness of the fingerprints and associates each of the ten fingers with commands available to a user. As a result, each command has a unique identifier associated with that command and there is no confusion among commands. Each of the fingerprints, when detected by the fingerprint authentication and actuation unit 100 may represent a command to the user.

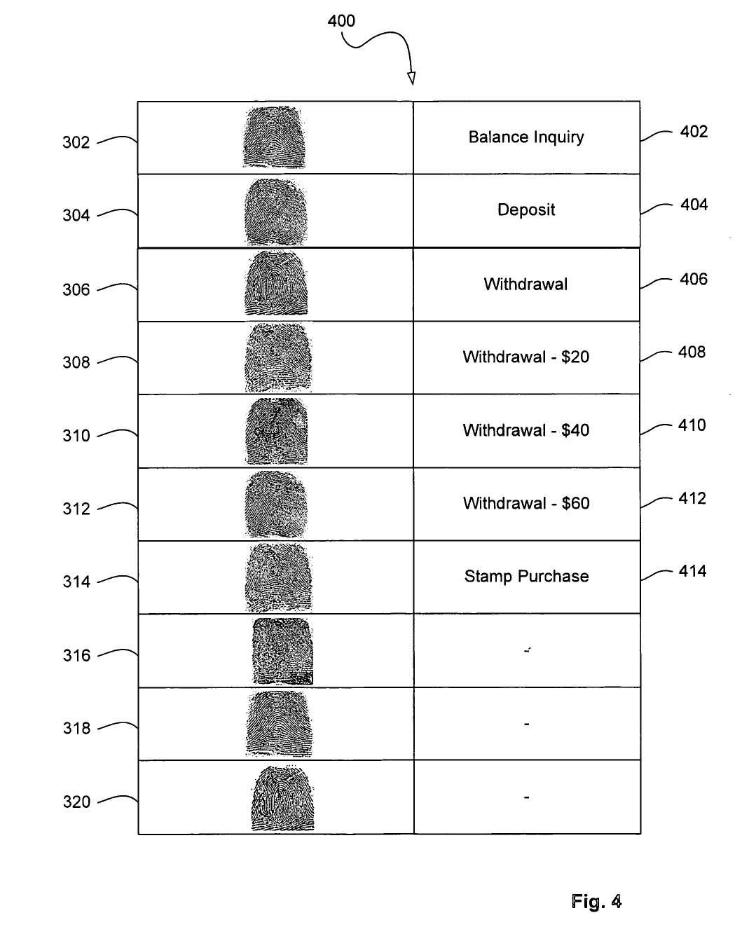

FIG. 4 illustrates a table of commands that may be associated with each of the fingerprints of a user. In one embodiment, the table of commands is associated with an automated teller machine 204. Operation commands for an automated teller machine 204 includes for example balance inquiry 402, deposit 404, withdrawal 406, twenty-dollar withdrawal 408, forty-dollar withdrawal 410, sixty-dollar withdrawal 412, and stamp purchase 414. While these commands are regularly configured to a specific series of inputs in a keypad associated with an automated teller machine 204, a user may also customize his commands to the automated teller machine 204 based on fingerprint input. For example, a user may choose to associate a command balance inquiry 402 with providing a fingerprint of his thumb to the fingerprint authentication and actuation unit 100. Upon scanning the fingerprint, the fingerprint authentication and actuation unit 100 first verifies the user identity by matching fingerprint data with previously stored fingerprint data associated with the user. The fingerprint recognition module 106 makes this comparison. Once the verification is done, the command is automatically executed. The processor at the fingerprint authentication and actuation unit 100 submits a command request to the automated teller machine 204. If the command is a balance inquiry 402, then the automated teller machine 204 may provide a printed copy or an on-screen display of the balance requested.

In another example, a user may choose to associate a deposit command 404 with providing a fingerprint 304 to the fingerprint authentication and actuation unit 100. In yet another example, a user may choose to associate a withdraw command 406 with providing a fingerprint 306 to the fingerprint authentication and actuation unit 100. In one example, a user may choose to associate a deposit command 404 with providing a fingerprint 308 to the fingerprint authentication and actuation unit 100. In one example, a user may choose to associate a twenty-dollar withdrawal command 408 with providing a fingerprint 310 to the fingerprint authentication and actuation unit 100. In yet another example, a user may choose to associate a forty-dollar withdrawal command 410 with providing a fingerprint 312 to the fingerprint authentication and actuation unit 100. In another example, a user may choose to associate a sixty-dollar withdrawal command 412 with providing a fingerprint 314 to the fingerprint authentication and actuation unit 100. In another example, a user may choose to associate a stamp purchase command 414 with providing a fingerprint 316 to the fingerprint authentication and actuation unit 100.

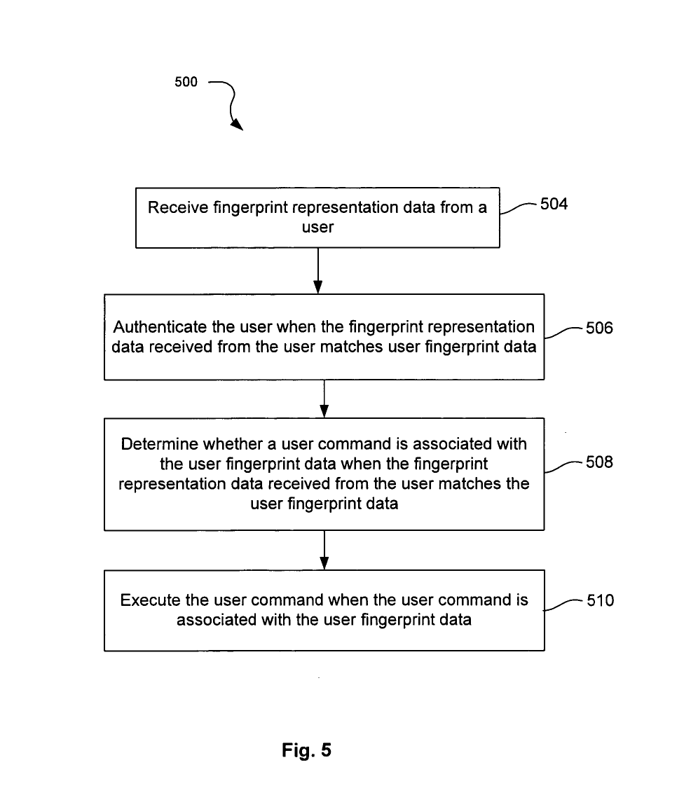

FIG. 5 illustrates a process flow diagram of the authentication and actuation of a fingerprint. In one embodiment, the process is performed by the authentication and actuation unit 100. In another embodiment, the process is performed by an authentication module, and an actuation module, both part of the authentication and actuation unit 100.

Process 500 starts at process block 504 wherein fingerprint representation data is received from the user. In one embodiment, the fingerprint representation data received form the user is received from the scanner 110 which scans an image of the fingerprint. In one embodiment, a determination is made whether or not a fingerprint is present on the scanner 110. If a fingerprint is not present on the scanner 110, the scanner continues on standby until a fingerprint is present to be scanned. The process 500 continues to process block 506.

At process block 506, a user is authenticated. In one embodiment, the user is authenticated when data representing the image of the scanned fingerprint is compared against the fingerprint data in the fingerprint database 102. In other words, if fingerprint representation data received form the user matches user fingerprint data at the fingerprint database 102 then the user is authenticated. Moreover, a determination is made at process block 506 as to whether the data representing the image of the scanned fingerprint matches data representing an image of at least one reference fingerprint stored the fingerprint database 102. In one embodiment, if the data representing the image of the scanned fingerprint, or fingerprint representation data, does not match data representing an image of at least one reference fingerprint stored the fingerprint database 102 then the user is not authenticated is denied access to the operating device 120. The process 500 continues to process block 508.

At process block 508, a determination is made as to whether or not there is a command associated with the received and matched fingerprint. If there is a command associated with the fingerprint, the associated command is executed at process block 510. In one embodiment, if there is no command associated with the fingerprint, any further manual commands and requests by the user may be processed. For example, if the user simply utilized fingerprint scanning process as authentication, and not actuation where a command is be performed, then the user may manually enter other commands.

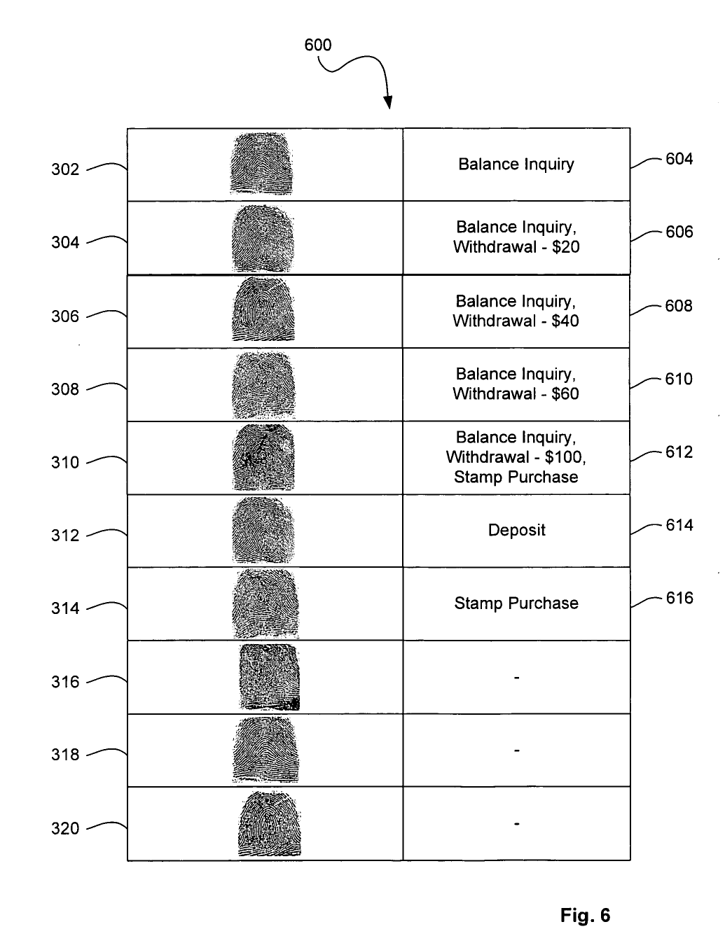

FIG. 6 illustrates a table of commands and command strings that may be associated with each of the fingerprints of a user. In one embodiment, a string of commands is associated with each fingerprint. In another embodiment, one single command is associated with a fingerprint. In yet another embodiment, a fingerprint has no associated commands and is utilized for accessing the operating device 102.

In one example, the table of commands 600 is associated with the automated teller machine 204. As discussed above, automated teller machines may provide commands such as withdrawal, deposit and balance inquiries. These commands generally require user input of a series of series of inputs in a keypad associated with an automated teller machine 204. However, if the automated teller machine 204 is coupled with an authentication and actuation unit 100, the user may also customize these commands to the automated teller machine 204 such that a fingerprint input may trigger a command or a string of commands to be executed.

For example, the fingerprint authentication and actuation unit 100 executes balance inquiry command 604 upon receiving a fingerprint 304. In another example, a user may choose to associate a command 602 with a fingerprint 306 to the fingerprint authentication and actuation unit 100. The command string 606 includes a balance inquiry and a twenty-dollar withdrawal. Upon scanning the fingerprint, the fingerprint authentication and actuation unit 100 first verifies the user identity by matching fingerprint data with previously stored fingerprint data associated with the user. In one embodiment, the fingerprint recognition module 106 makes this comparison. Once the verification is done, the command string is automatically executed. The processor at the fingerprint authentication and actuation unit 100 submits the command requests to the automated teller machine 204. In one example, the processor submits the commands one by one to the automated teller machine 204. In another example, the processor submits the command string to the automated teller machine 204. The automated teller machine 204 may then execute the commands in the command string. Thus, the automated teller machine 204 first provides a printed copy or an on-screen display of the balance requested. Then, the user is provided with the twenty-dollar withdrawal as requested.

In one example, a user may choose to associate a command string 608 with providing a fingerprint 306 to the fingerprint authentication and actuation unit 100. The command string 608 includes a balance inquiry and a forty-dollar withdrawal. In another example, a user may choose to associate a command string 610 with providing a fingerprint 308 to the fingerprint authentication and actuation unit 100. The command string 610 includes a balance inquiry and a sixty-dollar withdrawal. In yet another example, a user may choose to associate a command string 612 with providing a fingerprint 310 to the fingerprint authentication and actuation unit 100. The command string 612 includes a balance inquiry, a one hundred-dollar withdrawal, and stamp purchase.

In another example, a user may choose to associate a command string 614 with providing a fingerprint 312 to the fingerprint authentication and actuation unit 100. In yet another example, a user may choose to associate a deposit command 616 with providing a fingerprint 314 to the fingerprint authentication and actuation unit 100.

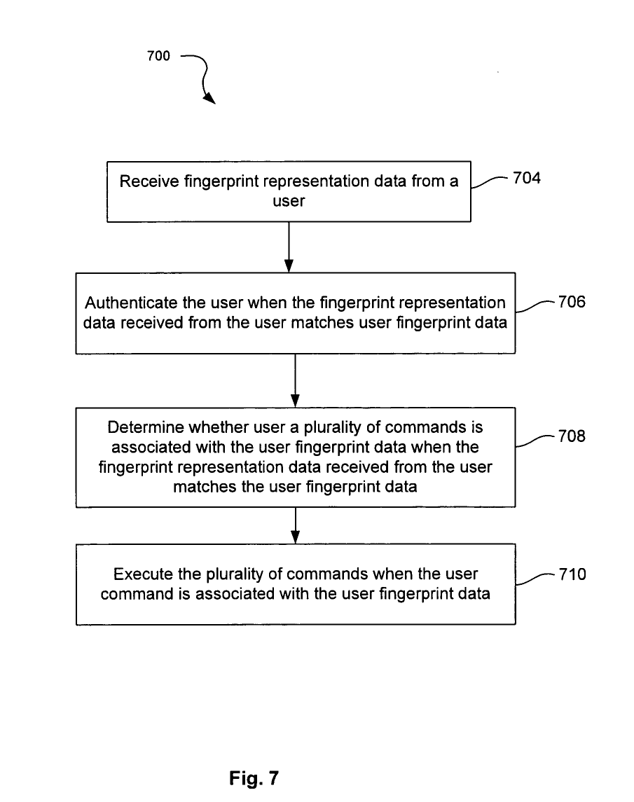

FIG. 7 illustrates a process flow diagram of the authentication and actuation of a fingerprint. In one embodiment, the process is performed by the authentication and actuation unit 100. In another embodiment, the process is performed by an authentication module, and an actuation module, both part of the authentication and actuation unit 100.

Process 700 starts at process block 704 wherein fingerprint representation data is received from the user. In one embodiment, the fingerprint representation data received form the user is received from the scanner 110 which scans an image of the fingerprint. In one embodiment, a determination is made whether or not a fingerprint is present on the scanner 110. If a fingerprint is not present on the scanner 110, the scanner continues on standby until a fingerprint is present to be scanned. The process 700 continues to process block 706.

At process block 706, a user is authenticated. In one embodiment, the user is authenticated when data representing the image of the scanned fingerprint is compared against the fingerprint data in the fingerprint database 102. In other words, if fingerprint representation data received form the user matches user fingerprint data at the fingerprint database 102 then the user is authenticated. Moreover, a determination is made at process block 706 as to whether the data representing the image of the scanned fingerprint matches data representing an image of at least one reference fingerprint stored the fingerprint database 102. In one embodiment, if the data representing the image of the scanned fingerprint, or fingerprint representation data, does not match data representing an image of at least one reference fingerprint stored the fingerprint database 102 then the user is not authenticated is denied access to the operating device 120. The process 700 continues to process block 708.

At process block 708, a determination is made as to whether or not there is a plurality of commands associated with the received and matched fingerprint. If there is a plurality of commands associated with the fingerprint, the associated commands are executed at process block 710. In one embodiment, if there are no commands associated with the fingerprint, any further manual commands and requests by the user may be processed. For example, if the user simply utilized fingerprint scanning process as authentication, and not actuation where a command is be performed, then the user may manually enter other commands.

Fingerprint Sequencing

As discussed above, fingerprints provide unique keys that may be associated with pre-established commands. In addition, to single fingerprints providing unique keys, a combination fingerprints may also be associated with a particular command or authentication. Thus, the authentication and actuation unit 100 may further be configured to recognize fingerprints scanned in a specific order and subsequently perform an operation or command based on the order in which the fingerprints were entered. The order of fingerprints provides another level of differentiation of commands and authentication schemes that may be applied to any electronic device that requires user interaction or authentication. Human fingerprints may operate as system commands that are unique to each user. Thus, fingerprint readings may provide user identification as well the capability to perform functions and actions based on the application and sequence of the fingerprint.

In one embodiment, a latency period is assigned in between the fingerprint readings such that if two fingerprints are read within a pre-determined amount of time the two fingerprints are deemed part of a fingerprint sequence. On the other hand, if the two fingerprints are read with enough time apart, then they are considered two separate fingerprint readings.

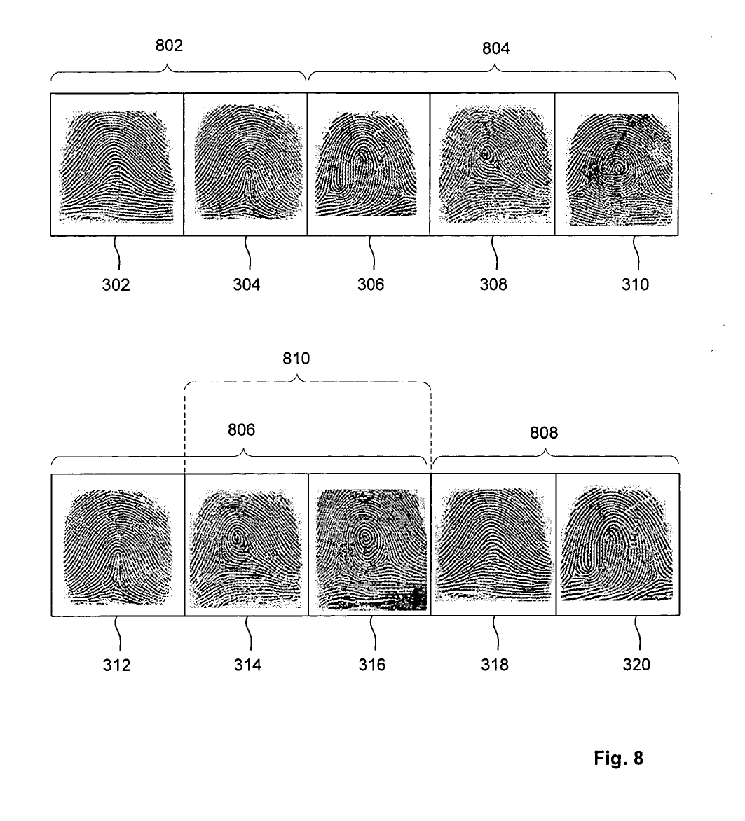

FIG. 8 illustrates fingerprint combinations that correspond to each of the fingerprints of a person. Multiple fingerprint combinations may exist. For example, fingerprint combination 802 corresponds to fingerprint 302 and fingerprint 304. In one embodiment, the fingerprint combination 802 is a sequence wherein fingerprint 304 is recognized first, and fingerprint 302 is recognized second. In another embodiment, the fingerprint combination 802 is a sequence wherein fingerprint 302 is recognized first, and fingerprint 304 is recognized second.

In another example, fingerprint combination 804 corresponds to fingerprint 306, fingerprint 308, and fingerprint 310. In one embodiment, the fingerprint combination 804 is recognized only if the three fingerprints are recognized simultaneously. Thus, the user would position the three fingers on the scanner 110 in order to provide the fingerprint combination 804.

In yet another example, a fingerprint combination 806 corresponds to fingerprint 312, fingerprint 314, and fingerprint 316. A fingerprint combination 808 corresponds to fingerprint 318, and fingerprint 320. Finally, a fingerprint combination 810 corresponds to fingerprint 314, and fingerprint 316.

In one embodiment, the authentication and actuation unit 100 requests the execution of a command to the operating device 120 based on a fingerprint combination. The fingerprint combination may be provided by the user in a specific order. In another embodiment, the authentication and actuation unit may execute a command associated with a fingerprint combination that may be provided by the user regardless of the order. For example, the fingerprint combination 806 may be recognized by the authentication and actuation unit 100 in one or more sequences. For example, a first sequence is fingerprint 312, fingerprint 314, and fingerprint 316 in order. In another example, a second sequence can be fingerprint 316, fingerprint 314, and fingerprint 312 in order. In another example, a third sequence is fingerprint 312, fingerprint 316, and fingerprint 314 in order. In one embodiment, the authentication and actuation unit 100 recognizes a command if the first or second sequences are provided by the user, but not if the third sequence is provided by the user. In another embodiment, the authentication and actuation unit 100 recognizes a first command for the first sequence and a second command for the second sequence.

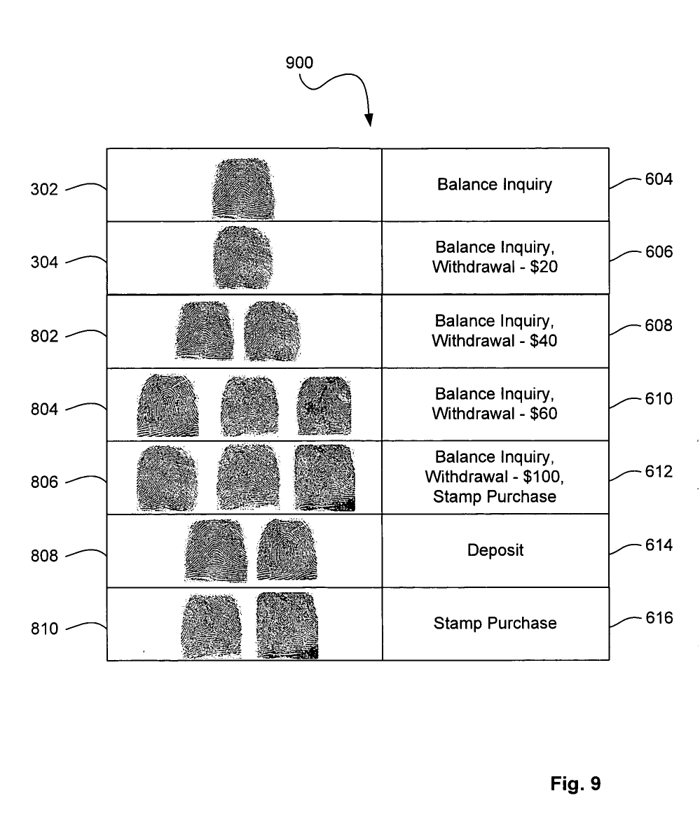

FIG. 9 illustrates a table of function commands that may be associated with each of the fingerprints and sequence of fingerprints of a user. In one embodiment, one single command is associated with a fingerprint sequence. In another embodiment, a string of commands is associated with a fingerprint sequence. In yet another embodiment, a fingerprint sequence has no associated commands and is utilized for accessing the operating device 102.

In one example, the table of commands 900 is associated with the automated teller machine 204. Thus, user commands to an automated teller machine 204 may be customized such that a fingerprint sequence input may trigger a command or a string of commands to be executed. For example, the fingerprint authentication and actuation unit 100 requests the automatic teller machine 204 a balance inquiry command 604 upon scanning and authenticating a fingerprint 302. In another example, a user may choose to associate a command string 606 with a fingerprint 304 such that the fingerprint authentication and actuation unit 100 requests execution of two commands. Thus, the command string 606 includes a balance inquiry command and a twenty-dollar withdrawal command. In one example, the processor submits the commands one by one to the automated teller machine 204. In another example, the processor submits the command string to the automated teller machine 204. The automated teller machine 204 executes the commands in the command string. Thus, the automated teller machine 204 first provides a printed copy or an on-screen display of the balance requested. The user may then be provided with the twenty-dollar withdrawal as requested.

In another example, a user may choose to associate a command string 608 with a fingerprint combination 802 such that the fingerprint authentication and actuation unit 100 requests execution of a balance inquiry command and a forty-dollar withdrawal command. The fingerprint authentication and actuation unit 100 may receive the fingerprint combination 802 in a predetermined order as discussed above. For example, as illustrated in FIG. 8, fingerprint 302 and fingerprint 304 may constitute part of fingerprint combination 802. If the user enters fingerprint 302 (e.g. thumb) and fingerprint 304 (e.g. index finger), in that order, then the authentication and actuation unit 100 compares the sequence in the user profile 104 to determine if there is an associated command with that sequence of fingerprints. If there is, then the sequence of commands is executed. As illustrated in FIG. 9, the sequence of commands corresponding to fingerprint combination 802 is a balance inquiry and a forty-dollar withdrawal. Thus, the fingerprint authentication and actuation unit 100 upon receiving the fingerprint combination 802, requests the automatic teller machine 204 to provide a balance amount and the forty-dollar request.

In yet another example, a user may choose to associate a command string 610 with fingerprint combination 804. The command string 610 includes a balance inquiry and a sixty-dollar withdrawal. Upon authenticating fingerprint combination 804 the fingerprint authentication and actuation unit 100 may request execution of the command string 610. In one example, a user may choose to associate a command string 612 with fingerprint combination 806. The command string 612 may include a balance inquiry, a one hundred-dollar withdrawal, and stamp purchase. Upon authenticating fingerprint combination 806, the fingerprint authentication and actuation unit 100 requests execution of the command string 612. In another example, a user may choose to associate a command string 614 with the fingerprint combination 808. The command 614 may include a deposit request. Upon authenticating the fingerprint combination 808, the fingerprint authentication and actuation unit 100 may request execution of the command string 614. In another example, a user may choose to associate a command string 616 with fingerprint combination 810. The command 616 may include a stamp purchase. Upon authenticating fingerprint combination 810 the fingerprint authentication and actuation unit 100 requests execution of the command string 616.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. For instance, various combinations of the operable device may be utilized. For example, the fingerprint authentication and actuation unit may be utilized with a pager, a personal notebook, a personal computer, a personal organizer, a data terminal, a two-way radio, an internet access device, an email access device, a vehicle, an airplane, secure-access systems, military systems, televisions, radios, DVD players, CD players, kitchen appliances, etc. Accordingly, it is intended that the art disclosed shall be limited only to the extent required by the appended claims and the rules and principles of applicable law.

What is claimed is:

1. A method of providing combined secure access and command execution for an electronic device, comprising:
receiving fingerprint representation data from a user;
authenticating the user when the fingerprint representation data received from the user matches user fingerprint data;
determining whether a user command is associated with the user fingerprint data when the fingerprint representation data received from the user matches the user fingerprint data; and
executing the user command when the user command is associated with the user fingerprint data.

2. The method of claim 1, wherein the user fingerprint data is stored in a fingerprint database communicably coupled with the electronic device.

3. The method of claim 1, wherein the user command is stored in a user profile database communicably coupled with the fingerprint database.

4. The method of claim 1, wherein the user fingerprint data corresponds to a fingerprint of the user, a sequence of fingerprints of the user, or a combination of fingerprints of the user.

5. The method of claim 1, wherein the user command comprises a plurality of commands and the user fingerprint data corresponds to a finger of the user.

6. The method of claim 1, wherein the user command comprises a plurality of commands and the user fingerprint data corresponds to a sequence of fingerprints of the user.

7. The method of claim 1, wherein the user command comprises a plurality of commands and the user fingerprint data corresponds to a combination of fingerprints of the user.

8. The method of claim 1, wherein the user command is a command to operate the electronic device.

9. The method of claim 1, wherein the user command is a plurality of commands to operate the electronic device.

10. The method of claim 1, wherein the electronic device is a personal computer, an automated teller machine, a control console in a vehicle, a videophone, a secure access computer, or a wireless portable device.

11. A system that provides combined secure access and command execution for an electronic device, comprising:
a fingerprint database that stores user fingerprint data;
a fingerprint recognition module the authenticates the user by determining if fingerprint representation data received from a user matches user fingerprint data stored in the fingerprint database;
a user maintenance module that determines whether a user command is associated with the fingerprint representation data; and
a computer processor that executes the user command when the user command is associated with the user fingerprint data.

12. The method of claim 1, wherein the user command is stored in a user profile database communicably coupled with the fingerprint database.

13. The system of claim 11, wherein the user fingerprint data corresponds to a fingerprint of the user.

14. The system of claim 11, wherein the user fingerprint data corresponds to a sequence of fingerprints of the user, or a combination of fingerprints of the user.

15. The system of claim 11, wherein the user command comprises a plurality of commands and the user fingerprint data corresponds to a finger of the user.

16. The system of claim 11, wherein the user command comprises a plurality of commands and the user fingerprint data corresponds to a sequence of fingerprints of the user.

17. The system of claim 11, wherein the user command comprises a plurality of commands and the user fingerprint data corresponds to a combination of fingerprints of the user.

18. The system of claim 11, wherein the user command is a command to operate the electronic device.

19. The system of claim 11, wherein the user command is a plurality of commands to operate the electronic device.

20. The system of claim 11, wherein the electronic device is a personal computer, an automated teller machine, a control console in a vehicle, a videophone, a secure access computer, or a wireless portable device.
